(19) United States
(12) Patent Application Publication
(10) Pub. No.: US 2020/0158835 A1
(43) Pub. Date: May 21, 2020

(54) TIME-OF-FLIGHT RANGING SENSOR AND TIME-OF-FLIGHT RANGING METHOD

(71) Applicant: GenOptics Precision Biotechnologies Inc., New Taipei City (TW)

(72) Inventor: Teng-Chien Yu, Hsinchu City (TW)

(73) Assignee: GenOptics Precision Biotechnologies Inc., New Taipei City (TW)

(21) Appl. No.: 16/672,511

(22) Filed: Nov. 3, 2019

Related U.S. Application Data
(60) Provisional application No. 62/768,103, filed on Nov. 16, 2018.

(51) Int. Cl. G01S 7/486; G01S 17/89

(52) U.S. Cl. CPC G01S 7/4865; G01S 7/484; G01S 7/4861; G01S 17/89

(57) ABSTRACT

A time-of-flight ranging sensor and a time-of-flight ranging method are provided. The time-of-flight ranging sensor includes a signal processing circuit, a light emitter, and a light sensor. The light emitter emits a pulsed light having a first polarization direction to a sensing target. The light sensor senses the pulsed light reflected by the sensing target to output a first sensing signal via a first sub-pixel repeating unit and output a second sensing signal via a second sub-pixel repeating unit to the signal processing circuit. The signal processing circuit determines a pulse signal according to the first sensing signal and the second sensing signal, and the signal processing circuit determines a depth information of the sensing target according to the pulsed light and the pulse signal.

### CROSS-REFERENCE TO RELATED APPLICATION

This application claims the priority benefit of U.S. provisional application Ser. No. 62/768,103, filed on Nov. 16, 2018. The entirety of the above-mentioned patent application is hereby incorporated by reference herein and made a part of this specification.

### BACKGROUND OF THE INVENTION

### Field of the Invention

The invention relates to a sensor, and more particularly to a time-of-flight (ToF) ranging sensor and a time-of-flight ranging method.

### Description of Related Art

With the evolution of ranging techniques, various ranging techniques have been continuously developed and widely used in, for example, vehicle distance detection, face recognition, and various Internet-of-Things (IoT) equipment. Common ranging techniques are, for example, infrared radiation (IR) techniques, ultrasound ranging techniques, and intense pulsed light (IPL) ranging techniques. However, with the increasing demand for the accuracy of ranging, pulsed light ranging techniques using the Time-of-Flight (ToF) measurement method is currently one of the main research directions in the field. In this regard, the solutions of several embodiments are presented below on how to improve the accuracy of ToF ranging.

### SUMMARY OF THE INVENTION

The invention provides a time-of-flight (ToF) ranging sensor and a ToF ranging method that may provide an effect of accurately sensing a distance between the ToF ranging sensor and the sensing target.

The ToF ranging sensor of the invention includes a signal processing circuit, a light emitter, and a light sensor. The light emitter is coupled to the signal processing circuit. The light emitter is configured to emit a pulsed light having a first polarization direction to a sensing target. The light sensor is coupled to the signal processing circuit. The light sensor is configured to sense the pulsed light reflected by the sensing target to output a first sensing signal via a first sub-pixel repeating unit and output a second sensing signal via a second sub-pixel repeating unit to the signal processing circuit. The first sub-pixel repeating unit includes a plurality of color sub-pixel units and a first pulsed light sensing unit having a first polarization direction. The second sub-pixel repeating unit includes a plurality of other color sub-pixel units and a second pulsed light sensing unit having a second polarization direction. The signal processing circuit determines a pulse signal according to the first sensing signal and the second sensing signal. The signal processing circuit determines a depth information of the sensing target according to the pulsed light and the pulse signal.

The ToF ranging method of the invention includes the following steps. A pulsed light having a first polarization direction is emitted to a sensing target via a light emitter. The pulsed light reflected by the sensing target is sensed by a light sensor to output a first sensing signal via a first sub-pixel repeating unit and output a second sensing signal via a second sub-pixel repeating unit. A pulse signal is determined according to the first sensing signal and the second sensing signal via a signal processing circuit, and a depth information of the sensing target is determined according to the pulsed light and the pulse signal. The first sub-pixel repeating unit includes a plurality of color sub-pixel units and a first pulsed light sensing unit having a first polarization direction. The second sub-pixel repeating unit includes a plurality of other color sub-pixel units and a second pulsed light sensing unit having a second polarization direction.

Based on the above, the ToF ranging sensor and the ToF ranging method of the invention may effectively reduce or eliminate the influence of background noise via the polarized design of the pulsed light and the light sensor to improve the accuracy of ranging.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a Time-of-Flight (ToF) ranging sensor according to an embodiment of the invention.

FIG. 2 is a block diagram of a light sensor according to an embodiment of the invention.

FIG. 3A is a schematic diagram of a first sub-pixel repeating unit according to an embodiment of the invention.

FIG. 3B is a schematic diagram of a second sub-pixel repeating unit according to an embodiment of the invention.

FIG. 4 is a timing diagram of a plurality of signal waveforms according to an embodiment of the invention.

FIG. 5 is a timing diagram of a pulse signal according to an embodiment of the invention.

FIG. 6 is a timing diagram of a pulse signal according to another embodiment of the invention.

FIG. 7 is a flowchart of a ToF ranging method according to an embodiment of the invention.

### DESCRIPTION OF THE EMBODIMENTS

To make the contents of the invention more easily understood, embodiments are provided below as examples of the plausibility of implementation of the invention. Moreover, when applicable, devices/components/steps having the same reference numerals in figures and embodiments represent the same or similar parts.

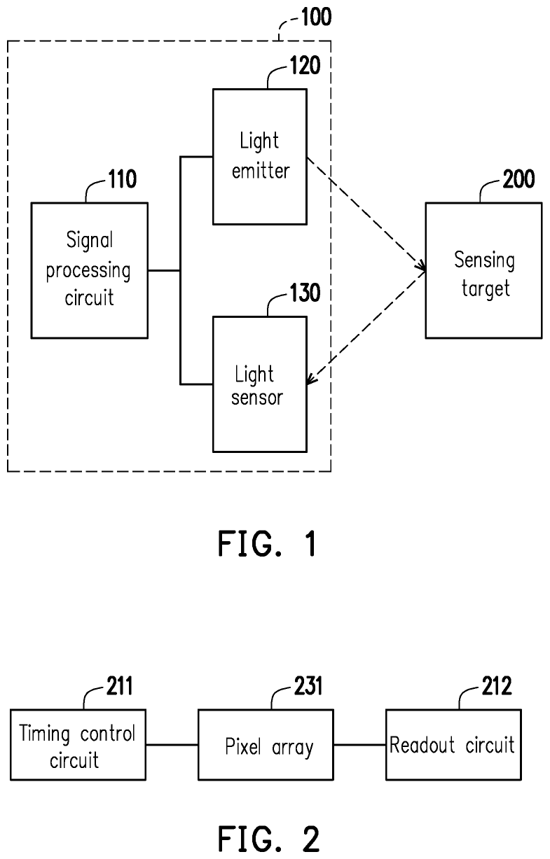

FIG. 1 is a block diagram of a Time-of-Flight (ToF) ranging sensor according to an embodiment of the invention. Referring to FIG. 1, a ToF ranging sensor 100 includes a signal processing circuit 110, a light emitter 120, and a light sensor 130. The signal processing circuit 110 is coupled to the light emitter 120 and the light sensor 130. The signal processing circuit 110 may include a digital circuit and an analog circuit, and is not limited in the invention. In the present embodiment, the light emitter 120 may be, for example, a pulsed light emitter or a laser diode, and the light sensor 130 may be, for example, a complementary metal oxide semiconductor (CMOS) image sensor (CIS). The light emitter 120 is configured to emit an infrared radiation (IR) light pulse. In the present embodiment, the signal processing circuit 110 drives the light emitter 120 and the light sensor 130 such that the light emitter 120 emits a pulsed light to a sensing target 200 and the light sensor 130 senses the pulsed light reflected by the sensing target 200.

In the present embodiment, the light sensor 130 may include a first sub-pixel repeating unit and a second sub-pixel repeating unit. The first sub-pixel repeating unit includes a plurality of color sub-pixel units and a first pulsed light sensing unit having a first polarization direction. The second sub-pixel repeating unit includes a plurality of other color sub-pixel units and a second pulsed light sensing unit having a second polarization direction. Therefore, the light sensor 130 of the present embodiment may be configured to obtain color image information, infrared image information, and depth information. Further, in the present embodiment, the light emitter 120 may emit, for example, a pulsed light having a vertical polarization direction or a pulsed light having a horizontal polarization direction to the sensing target 200.

In particular, since the light sensor 130 senses background noise at the same time during the sensing process, the light sensor 130 of the present embodiment may respectively output a plurality of sensing results via the first pulsed light sensing unit and the second pulsed light sensing unit having different polarizations. In the present embodiment, the first sub-pixel repeating unit and the second sub-pixel repeating unit are, for example, repeatedly staggered and arranged in an array on a pixel substrate, but the invention is not limited thereto. In the present embodiment, the signal processor 110 may correctly obtain a signal waveform corresponding to the pulsed light after the sensing results of the first sub-pixel repeating unit and the second sub-pixel repeating unit are calculated, so that the distance between the ToF ranging sensor 100 and the sensing target 200 may be accurately calculated.

For example, the signal processing circuit 110 may convert the light path length of the pulsed light according to the time from when the pulsed light is emitted to when the reflected pulsed light is sensed, and one-half of the light path length is the distance between the ToF ranging sensor 100 and the sensing target 200. In other words, the ToF ranging sensor 100 of the present embodiment may utilize different sensing results of polarization to distinguish the polarized pulsed light reflected by the sensing target 200 and background noise corresponding to ambient light, and the ToF ranging sensor 100 may be applied to pulsed light of various signal strengths.

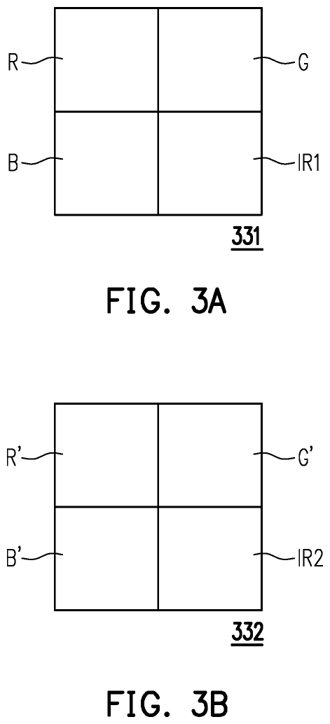

FIG. 2 is a block diagram of a light sensor according to an embodiment of the invention. FIG. 3A is a schematic diagram of a first sub-pixel repeating unit according to an embodiment of the invention. FIG. 3B is a schematic diagram of a second sub-pixel repeating unit according to an embodiment of the invention. Referring to FIG. 1 to FIG. 3B, the light sensor 130 of FIG. 1 may further include, for example, a pixel array 231 of FIG. 2, and the pixel array 231 is coupled to a timing control circuit 211 and a readout circuit 212. In the present embodiment, the pixel array 231 of FIG. 2 may include a first sub-pixel repeating unit 331 as shown in FIG. 3A and a second sub-pixel repeating unit 332 as shown in FIG. 3B. In other words, a plurality of the first sub-pixel repeating unit 331 and a plurality of the second sub-pixel repeating unit 332 may be staggered to form an array, but the invention does not limit the arrangement of the first sub-pixel repeating units 331 and the second sub-pixel repeating units 332 in the pixel array 231.

Furthermore, a color filter may be separately disposed or formed on each sub-pixel unit of the pixel array 231. In the present embodiment, the first sub-pixel repeating units 331 may include a plurality of color pixel units and a first pulsed light sensing unit IR1. The plurality of color pixel units include, for example, a red sub-pixel unit R, a green sub-pixel unit G, and a blue sub-pixel unit B. In the present embodiment, the second sub-pixel repeating units 332 may include a plurality of other color pixel units and a first pulsed light sensing unit IR2. The plurality of other color pixel units include, for example, a red sub-pixel unit R′, a green sub-pixel unit G′, and a blue sub-pixel unit B′.

In the present embodiment, the timing control circuit 211 is configured to provide a timing signal to control the pixel array 231 to perform an image sensing operation or a ranging operation. When the pixel array 231 performs an image sensing operation, the red sub-pixel units R and R′, the green sub-pixel units G and G′, and the blue sub-pixel units B and B′ of the first sub-pixel repeating units 331 and the second sub-pixel repeating units 332 may provide color image information, and may provide infrared light image information with the first pulsed light sensing unit IR1 and the second pulsed light sensing unit IR2. However, when the pixel array 231 performs a ranging operation, the red sub-pixel units R and R′, the green sub-pixel units G and G′, and the blue sub-pixel units B and B′ of the first sub-pixel repeating units 331 and the second sub-pixel repeating units 332 may be disabled, and the first sub-pixel repeating units 331 and the second sub-pixel repeating units 332 may perform ranging via only the first pulsed light sensing unit IR1 and the second pulsed light sensing unit IR2.

In the present embodiment, the first pulsed light sensing unit IR1 may have a first polarization direction, and the second pulsed light sensing unit IR2 may have a second polarization direction. In this regard, the light emitter 120 may emit a pulsed light having, for example, a vertical polarization direction to the sensing target 200, and the sensing target 200 reflects the pulsed light having the vertical polarization direction to the first pulsed light sensing unit IR1 having a vertical polarization direction and the second pulsed light sensing unit IR2 having a horizontal polarization direction in the light sensor 130. Therefore, the first pulsed light sensing unit IR1 of the light sensor 130 may output a first sensing signal according to the pulsed light having the vertical polarization direction and corresponding to ambient light, and the first sensing signal includes a pulse signal corresponding to the pulsed light and a first background noise signal having a vertical polarization direction corresponding to a portion of the overall background noise. The second pulsed light sensing unit IR2 of the light sensor 130 may output a second sensing signal, and the second sensing signal includes a second background noise signal having a horizontal polarization direction corresponding to another portion of the overall background noise of ambient light. It is to be noted that since the polarization directions of the second pulsed light sensing unit IR2 and the pulsed light are different, the second sensing signal does not include a pulse signal corresponding to the pulsed light.

Further, since the signal strength of the first background noise signal is the same as or similar to the signal strength of the second background noise signal, the signal processing circuit 110 of the present embodiment may perform a signal strength subtraction operation on the first sensing signal and the second sensing signal obtained via different pixel units having different polarizations in one frame operation to obtain a signal waveform of a pulse signal without background noise. That is to say, the signal processing circuit 110 of the present embodiment may accurately calculate the distance between the ToF ranging sensor 100 and the sensing target 200 according to the time difference between when the light emitter 120 emits the polarized pulsed light and when the light sensor 130 senses the pulsed signal.

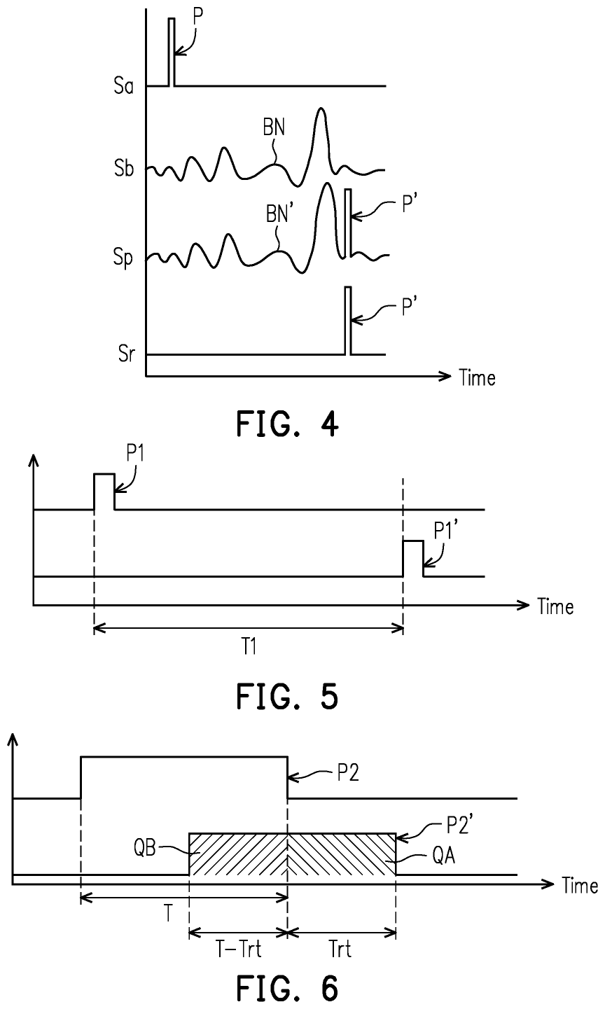

FIG. 4 is a timing diagram of a plurality of signal waveforms according to an embodiment of the invention. Referring to FIG. 1 to FIG. 4, for example, the light emitter 120 may emit a pulsed light having a vertical polarization direction according to a voltage signal Sa. The voltage signal Sa includes a pulse signal P. Next, the first pulsed light sensing unit IR1 having the vertical polarization direction and the second pulsed light sensing unit IR2 having the horizontal polarization direction are enabled to continue sensing. The first pulsed light sensing unit IR1 may output a voltage signal Sp as shown in FIG. 4, and the second pulsed light sensing unit IR2 may output a voltage signal Sb as shown in FIG. 4.

In the present embodiment, since the polarization directions of the first pulsed light sensing unit IR1 and the pulsed light are the same, the voltage signal Sp outputted via the first pulsed light sensing unit IR1 may include a background noise signal BN′ corresponding to ambient light and a pulse signal P′. In the present embodiment, since the polarization directions of the second pulsed light sensing unit IR2 and the pulsed light are different, the voltage signal Sp outputted via the second pulsed light sensing unit IR2 includes the background noise signal BN′ corresponding to ambient light. In the present embodiment, the background noise signals BN and BN′ have the same signal strength. Therefore, the signal processing circuit 110 may output a voltage signal Sr by comparing the voltage signals Sp and Sb, and the voltage signal Sr only has the pulse signal P′ and does not have a signal of background noise.

In the present embodiment, the signal processing circuit 110 may obtain a readout signal according to a rising edge of the pulse signal P′ of the voltage signal Sr. Therefore, the signal processing circuit 110 may determine the distance between the ToF ranging sensor 100 and the sensing target 200 according to the time difference between when the light emitter 120 emits the pulsed light and when the readout signal corresponding to the rising edge of the pulse signal P′ occurs. It should be noted that, according to the signal processing method, even if the signal strengths of the background noise signals BN and BN′ are higher than the pulse signals P and P′, the signal processing circuit 110 of the present embodiment may still effectively perform distance sensing and may obtain accurate distance sensing results.

FIG. 5 is a signal timing diagram of a pulse signal according to an embodiment of the invention. Referring to FIG. 1 and FIG. 5, after the signal processing circuit 110 obtains a pulse signal without background noise corresponding to the pulsed light sensed via the light sensor 130, the signal processing circuit 110 may obtain the transit time of the pulsed light by performing a Direct Time-of-Flight (D-ToF) ranging operation to calculate the depth information of the sensing target 200. The depth information of the sensing target 200 refers to the distance between the ToF ranging sensor 100 and the sensing target 200. Specifically, the signal processing circuit 110 may calculate the depth information of the sensing target 200 according to a time difference T1 between when the light emitter 120 emits a pulsed light (a pulse signal P1) and when the light sensor 130 senses the reflected pulsed light (a pulse signal P1′). The time difference T1 may be, for example, the length of time between the rising edge of the pulse signal P1 and the rising edge of the pulse signal P1′. That is, in the present embodiment, the signal processing circuit 110 can, for example, multiply the time difference T1 by the speed of light (C) and divide the result by 2 to obtain the distance (distance=(T1×C)/2).

FIG. 6 is a signal timing diagram of a pulse signal according to another embodiment of the invention. Referring to FIG. 1 and FIG. 6, after the signal processing circuit 110 obtains a pulse signal without background noise corresponding to the pulsed light sensed via the light sensor 130, the signal processing circuit 110 may obtain the transit time of the pulsed light by performing an Indirect Time-of-Flight (I-ToF) ranging operation to calculate the depth information of the sensing target 200. Specifically, the signal processing circuit 110 may calculate a round trip time Trt between when the light emitter 120 emits a pulsed light (a pulse signal P2) and when the light sensor 130 senses the pulsed light (a pulse signal P2′) reflected by the sensing target 200 and calculate the depth information of the sensing target 200 based on the round trip time Trt.

For example, the pulsed light sensing unit of the light sensor 130 may further include two capacitor units, and when the pulsed light sensing unit senses the pulsed light reflected by the sensing target 200, the pulsed light sensing unit stores energy via the capacitor units to obtain the capacity corresponding to an amount of incoming light QA and the capacity corresponding to an amount of incoming light QB. Therefore, the signal processing circuit 110 may obtain, for example, the corresponding parameter, value, or capacity of the amount of incoming light QA and the amount of incoming light QB to perform the calculations of the following equations (1) to (4).

In this regard, based on the derivation of the following equations (1) to (4), the amount of incoming light QA is equal to the round trip time Trt multiplied by a reflected light intensity R, and the amount of incoming light QB is equal to the pulse width minus the round trip time (T−Trt) and multiplied by the reflected light intensity R. Therefore, the signal processing circuit 110 may perform the calculation of the following equation (4) to obtain a distance D, wherein C is the speed of light parameter. The distance D is the depth information of the sensing target 200. In other words, the distance D is the distance between the ToF ranging sensor 100 and the sensing target 200.

$$\begin{matrix}QA = Trt \times R & ( 1 ) \\ QB = ( T - Trt ) \times R & ( 2 ) \\ QA + QB = T \times R & ( 3 ) \\ D = C \times \frac{Trt}{2} = \frac{C}{2} \times T \times ( \frac{QA}{QA + QB} ) & ( 4 )\end{matrix}$$

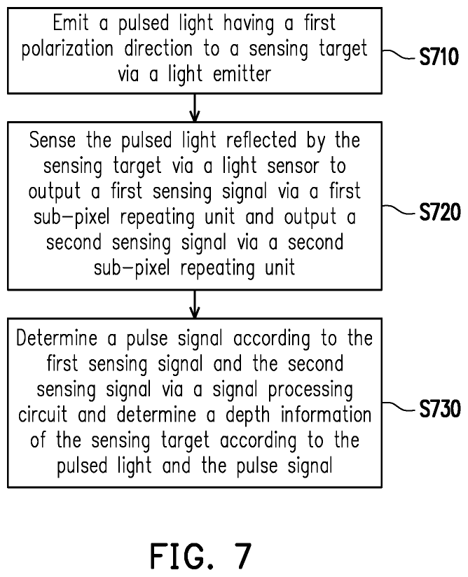

FIG. 7 is a flowchart of a ToF ranging method according to an embodiment of the invention. Referring to FIG. 1 and FIG. 7, the ToF ranging method of the present embodiment may be applied at least to the ToF ranging sensor 100 of the embodiment of FIG. 1. In step S710, the light emitter 120 emits a pulsed light having a first polarization direction to the sensing target 200. In step S720, the light sensor 130 senses the pulsed light reflected by the sensing target 200 to output a first sensing signal via a first sub-pixel repeating unit and output a second sensing signal via a second sub-pixel repeating unit. In step S730, the signal processing circuit 110 determines a pulse signal according to the first sensing signal and the second sensing signal and determines a depth information of the sensing target 200 according to the pulsed light and the pulse signal. Therefore, the ToF ranging method of the present embodiment may accurately sense the depth information of the sensing target 200. The depth information of the sensing target 200 refers to the distance between the ToF ranging sensor 100 and the sensing target 200.

In addition, regarding other circuit features, implementation means, and technical details of the ToF ranging sensor 100 of the present embodiment, sufficient teaching, suggestion, and implementation description may be obtained with reference to the embodiments of FIG. 1 to FIG. 6. Therefore, other circuit features, implementation means, and technical details of the ToF ranging sensor 100 are not repeated herein.

Based on the above, in the ToF ranging sensor and the ToF ranging method of the invention, a pulsed light having a first polarization direction reflected by the sensing target may be sensed via the first sub-pixel repeating unit having a first polarization direction and the second sub-pixel repeating unit having a second polarization direction to obtain a first sensing signal having a pulse signal and a first background noise signal and a second sensing signal having only a second background noise signal. Then, the ToF ranging sensor of the invention may perform a signal strength subtraction operation on the first sensing signal and the second sensing signal to effectively obtain a pulse signal corresponding to the pulsed light reflected by the sensing target. Therefore, the ToF ranging sensor of the invention may calculate the depth information of the sensing target via a D-ToF ranging operation or an I-ToF ranging operation, that is, the distance between the ToF ranging sensor and the sensing target. The ToF ranging sensor and the ToF ranging method of the invention may effectively reduce or eliminate the influence of background noise to improve the accuracy of ranging.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A time-of-flight ranging sensor, comprising:
a signal processing circuit;
a light emitter coupled to the signal processing circuit and configured to emit a pulsed light having a first polarization direction to a sensing target; and
a light sensor coupled to the signal processing circuit and configured to sense the pulsed light reflected by the sensing target to output a first sensing signal via a first sub-pixel repeating unit and a second sensing signal via a second sub-pixel repeating unit to the signal processing circuit,
wherein the first sub-pixel repeating unit comprises a plurality of color sub-pixel units and a first pulsed light sensing unit having the first polarization direction, and the second sub-pixel repeating unit comprises a plurality of other color sub-pixel units and a second pulsed light sensing unit having a second polarization direction,
wherein the signal processing circuit determines a pulse signal according to the first sensing signal and the second sensing signal, and the signal processing circuit determines a depth information of the sensing target according to the pulsed light and the pulse signal.

2. The time-of-flight ranging sensor of claim 1, wherein during a ranging, the light sensor obtains the first sensing signal and the second sensing signal via the first pulsed light sensing unit of the first sub-pixel repeating unit and the second pulsed light sensing unit of the second sub-pixel repeating unit.

3. The time-of-flight ranging sensor of claim 1, wherein the signal processing circuit performs a direct time-of-flight ranging operation to calculate the depth information of the sensing target according to a time difference between when the light emitter emits the pulsed light and when the light sensor senses the pulse signal.

4. The time-of-flight ranging sensor of claim 1, wherein the signal processing circuit performs an indirect time-of-flight ranging operation to calculate a round-trip time of the pulsed light and calculate the depth information of the sensing target according to the round-trip time.

5. The time-of-flight ranging sensor of claim 1, wherein the first sensing signal comprises the pulse signal and a first background noise signal, and the second sensing signal comprises a second background noise signal, wherein signal strengths of the first background noise signal and the second background noise signal are the same, and polarization directions of the first background noise signal and the second background noise signal are different.

6. The time-of-flight ranging sensor of claim 5, wherein the signal processing circuit performs a signal strength subtraction operation on the first sensing signal and the second sensing signal to obtain the pulse signal.

7. The time-of-flight ranging sensor of claim 1, wherein the color pixel units and the other color pixel units respectively comprise a red sub-pixel unit, a green sub-pixel unit, and a blue sub-pixel unit.

8. The time-of-flight ranging sensor of claim 1, wherein the first pulsed light sensing unit and the second pulsed light sensing unit are respectively an infrared sub-pixel unit.

9. The time-of-flight ranging sensor of claim 1, wherein the second polarization direction is perpendicular to the first polarization direction.

10. A time-of-flight ranging method, comprising:
transmitting a pulsed light having a first polarization direction to a sensing target via a light emitter;
sensing the pulsed light reflected by the sensing target via a light sensor to output a first sensing signal via a first sub-pixel repeating unit and output a second sensing signal via a second sub-pixel repeating unit; and
determining a pulse signal according to the first sensing signal and the second sensing signal via a signal processing circuit and determining a depth information of the sensing target according to the pulsed light and the pulse signal,
wherein the first sub-pixel repeating unit comprises a plurality of color sub-pixel units and a first pulsed light sensing unit having the first polarization direction, and the second sub-pixel repeating unit comprises a plurality of other color sub-pixel units and a second pulsed light sensing unit having a second polarization direction.
